(19) United States
(12) Patent Application Publication
(10) Pub. No.: US 2017/0226800 A1
(43) Pub. Date: Aug. 10, 2017

(54) FOLDABLE STEP STOOL

(71) Applicant: Dolores M. Barry, Cape Coral, FL (US)

(72) Inventor: Dolores M. Barry, Cape Coral, FL (US)

(21) Appl. No.: 15/040,406

(22) Filed: Feb. 10, 2016

(51) Int. Cl. E06C 1/00; A47B 88/04

(52) U.S. Cl. CPC E06C 1/005; A47B 88/0477; A47B 2220/05; A47B 2088/0081

(57) ABSTRACT

A foldable toe kick step stool comprising a cabinet adapted to provide a housing for a rack further housing a plurality of metal steps, a hinge mechanism for sliding the rack in a horizontally outward direction and means for sensing an operating a lifting mechanism for lifting a plurality of metal steps in a vertically upward direction. Further, the means for sensing is operably adapted to apply a hydraulic pressure mechanism for lifting the plurality of metal steps in a vertically upward direction which may be operated by an electric sensor or an actuator.

### FIELD OF THE INVENTION

The present invention relates to the field of foldable step stools having a sensing mechanism. More particularly, the invention relates to a foldable toe kick step stool structure which provides a means for sensing the lifting of the structure.

### BACKGROUND OF THE INVENTION

Today custom homes are being constructed having some form of built-in or custom cabinetry step stools in which homeowners are finding great uses for these step stools. Step stools are very practical to use if the homeowner needs to reach items stored in their kitchen cupboards if they don't have to stand on their toes and risk breaking them or having to strain their back and arms when they reach for something that's stored way up high. If someone works in an office, a folding step stool is an ideal tool when a person needs to reach for supplies or if the person needs to store some items or even files in very high storage spaces. Over the past few decades, modern kitchen, stores, and other related premises have improved step stools, partly as a result of ergonomic research. However, functionality is the primary consideration.

Commercially available step stools are designed to fold so that the front to rear dimension is greatly reduced. This permits the step stool to be stored more easily. However, this folding does not reduce the height of the step stool. Thus, a tall or long storage area is required even though the step stool may have assumed a much flatter configuration. There have been a number of solutions provided in the prior art for efficient and easy to store and use step stools in which: US patent publication 20150001005 issued to Goodson discloses a folding step stool that may be mounted within an interior of a cabinet. When not in use, the entirety of the folding step stool may be disposed within an interior of the cabinet to permit closure of the cabinet door. Likewise, when needed, the cabinet door may be opened and the step stool may be deployed to provide one or more steps for use in accessing a counter or sink above the cabinet. US patent publication 20080264723 issued to Tatum et al., describes a step stool for storing underneath a cabinet and extending therefrom when in use. The step stool includes a platform member for supporting a user. A mechanism is operably disposed on a bottom portion of the platform member and at least one side of the platform member at a predetermined location for facilitating movement of the step stool such that the step stool may be extended from underneath the cabinet during use and may be returned to a position underneath for storage. US patent publication 20140111072 issued to Camadella discloses a cabinet base for supporting a cabinet having a built-in step so that a user may reach higher cabinets. Further, the step is foot-operated wherein and no use of hands is necessary for its use. The step collapses into a drawer which slides into the cabinet base for storage.

Therefore a need exists for a step stool that can be integrated into a small cabinet thereby occupying less space but that upon use be deployed and retracted allowing the user a safe way to access high places such as out of the reach cabinets, storage files and the like. The present invention solves this in a unique and novel fashion.

### SUMMARY OF THE INVENTION

A foldable toe kick step stool is disclosed. The foldable toe kick step stool comprises a cabinet adapted to provide a housing for a rack further housing a plurality of metal steps, a hinge mechanism for sliding the rack in a horizontally outward direction and means for sensing an operating a lifting mechanism for lifting a plurality of metal steps in a vertically upward direction. Further, the means for sensing is operably adapted to apply a hydraulic pressure mechanism for lifting the plurality of metal steps in a vertically upward direction which may be operated by an electric sensor or an actuator.

It is an object of the present invention to provide a foldable toe kick step stool configured to have a frame or skeleton by a plurality of rods and bars.

It is another object of the present invention to provide a foldable toe kick step stool which may be moved from place to place along a cabinet, making it easy to reposition to facilitate access to many shelves with minimal installation requirements.

It is yet another object of the present invention to provide the foldable toe kick step stool structure has a very simple structure and profile, which allows easy installation in areas without an overhang or toe-kick area with a minimal danger of tripping.

Still yet another object of the present invention is to provide the foldable toe kick step stool having metal steps with non-slip top which provides a safe and secure platform for a user to stand on.

### BRIEF DESCRIPTION OF THE DRAWINGS

The invention will be better understood when consideration is given to the following detailed description thereof. Such description makes reference to the annexed drawings wherein:

FIG. 1 is a perspective view of a foldable toe kick step stool in accordance with an embodiment of the present invention;

FIG. 2 is another perspective view of the foldable toe kick step stool in accordance with an embodiment of the present invention;

FIG. 3 is a top plan view showing the metal steps of the foldable toe kick step stool in accordance with an embodiment of the present invention;

FIG. 4 is an perspective view showing the metal steps deployed and elevated of the foldable toe kick step stool sin accordance with an embodiment of the present invention; and

FIG. 5 is an elevation view showing the metal steps deployed and elevated of the foldable toe kick step stool in accordance with an embodiment of the present invention.

### DETAILED DESCRIPTION OF THE INVENTION

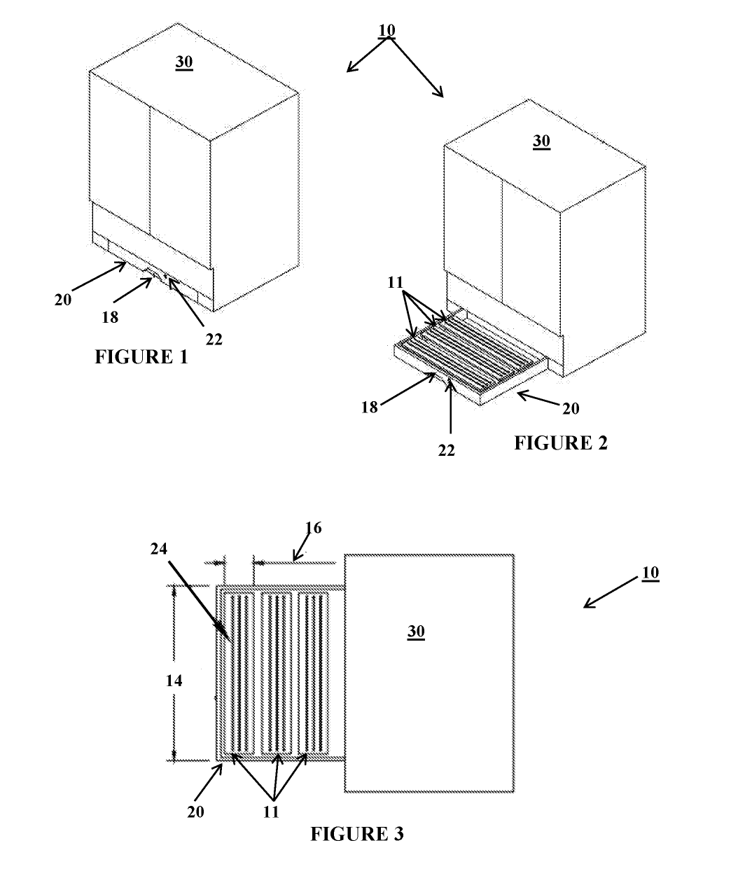

Referring now to FIGS. 1 through 5, there is shown a foldable toe kick step stool 10 in accordance with the present invention. The foldable toe kick step stool 10 comprises a cabinet 30 adapted to provide underneath a housing for a rack 20 which in turn houses a plurality of metal steps 11, a hinge mechanism 18 for sliding the rack 20 in an outward horizontal direction away from the cabinet 30 and means for sensing 22 operably adapted to apply a hydraulic pressure mechanism for lifting the plurality of metal steps 11 in a vertically upward direction and wherein the means for sensing 22 may be operated by an electric sensor or an actuator. In one preferred embodiment, the rack is thirty six inches 14 in width wherein each metal step is six inches 16 in width as shown in FIG. 3.

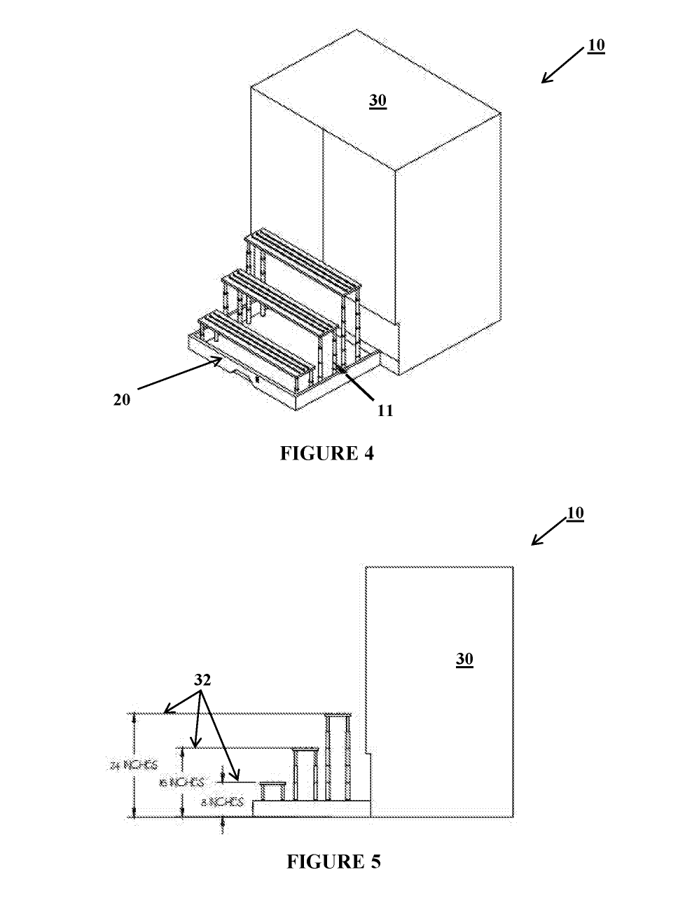

Turning once again to FIGS. 1 and 2 there are shown perspective views of the foldable toe kick step stool 10 in accordance the preferred embodiments of the present invention. As shown in FIGS. 1 and 2, the foldable toe kick step stool 10 comprises a cabinet 30, a rack 20 housing a plurality of collapsed and folded metal steps 11, a hinge mechanism 18 and means for sensing 22 for activating a lifting mechanism (not shown). Turning now to FIG. 3, Preferably, the means for sensing 22 is, but not limited to, configured to actuate a hydraulic pressure mechanism (not shown) for lifting the plurality of metal steps 11 in a vertically upward direction by an actuator or can be done with the help of electric sensor, as shown in FIGS. 4 and 5. The present invention provides a very efficient and simple structure having a means for sensing 22 the level of the plurality of metal steps by a sensor or an actuator. The sensor 22 helps the user in the uplifting of the plurality of metal steps. In accordance with an embodiment of the present invention, the plurality of metal steps 11 is configured to lift weight up to, but not limited to, 200-250 lbs. The size and height of the foldable toe kick step stool 10 as per the user need. Further, the foldable toe kick step stool 10 is, but not limited to, made of material selected from metallic and non-metallic group comprising recycled material, aluminum, stainless steel, iron, wood and combination thereof. Turning once again to FIG. 3, the foldable toe kick step stool has metal steps 11 with each step 11 defining a non-slip top 24 which provides a safe and secure platform to stand on. Also, the metal sliding rack 20 provides a mechanism for the structure to slide out. The foldable toe kick step stool 10 with sensor 22 contributes to a green and cleaned environment by using a plurality of recycled products.

Referring now to FIGS. 3 and 4, the step stool 10 has a plurality of levels 32 for elevating the plurality of metal steps 11 of the step stool 10 as per the need of the user. Preferably, the plurality of levels 32 for elevating the plurality of metal steps 11 of the step stool 10 is, but not limited to, at least three levels of elevation for raising the height of the plurality of metal steps 11 in a vertically upward direction. In the configurations as illustrated in FIGS. 3 and 4, the views showing the metal steps 11 deployed and elevated of the foldable toe kick step stool 10 in accordance with the present invention. The step stool 10 may have various sizes of metal steps 11 and a rack 20 dimensioned depending on the area and cabinet 30 for which the step stool 10 is to be utilized. The cabinet 30 is adapted to house the rack 20, which is further configured to house the plurality of metal steps 11. Lastly, the cabinet 30 may be fixed to a brace of a supporting wall when the metal steps 11 are not in use.

In summary, the present invention provides a step stool which has a plurality of levels for elevating the plurality of metal steps of the step stool structure as per the need of the user. Preferably, the plurality of levels for the plurality of metal steps of the step stool structure is, but not limited to, at least three levels of elevation for raising the height of the plurality of metal steps in vertically upward direction. The above-mentioned foldable toe kick step stool structure with a level sensor provides flexibility to users by controlling the level of the elevation, therefore avoid any danger of tripping or stumbling of the person. The foldable toe kick step stool structure directed to a fold-away step stool that folds into the interior of a cabinet when not in use and provides a step stool which is additionally characterized of being inexpensive in manufacturing. Further, the foldable toe kick step stool structure has three steps of different heights for helping the users in accessing bigger cabinets. It is easy to use and store as per the need of the user. Users can easily store it in the underneath of the cabinet. It eliminates the use of ladders in stores, home premise, office and the like places for accessing bigger cabinets. The foldable toe kick step stool structure that is permanently connected to a brace of a supporting wall and therefore cannot be misplaced.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A foldable toe kick step stool structure, comprising:
a cabinet adapted to provide a housing a rack wherein said rack houses a plurality of metal steps;
a hinge mechanism for sliding said rack in a horizontally outward direction; and
means for sensing a lifting mechanism for lifting said plurality of metal steps in a vertically upward direction.

2. The step stool structure according to claim 1, wherein said plurality of metal steps are collapsed and stored by said rack.

3. The step stool structure according to claim 1, wherein said rack is configured to have said plurality of metal steps.

4. The step stool structure according to claim 1, wherein said lifting mechanism is adjusted by a user.

5. The step stool structure according to claim 1, wherein said cabinet is fixed to a brace of a supporting wall.

6. The step stool structure according to claim 1, wherein said means for sensing is adapted to be housed by said rack.

7. The step stool structure according to claim 1, wherein said means for sensing is operably adapted to apply a hydraulic pressure mechanism for lifting said plurality of metal steps in said vertically upward direction.

8. The step stool structure according to claim 1, wherein said means for sensing is operably adapted to an electric sensor.

9. The step stool structure according to claim 1, wherein said step stool structure is made of material selected from metallic and non-metallic group comprising aluminum, stainless steel, iron, wood and combination thereof.

10. The step stool structure according to claim 1, wherein said hinge mechanism comprising at least one screw, at least one nut and at least one spring is operably adapted to provide said sliding mechanism.
